(19) United States
(12) Patent Application Publication
(10) Pub. No.: US 2006/0193129 A1
(43) Pub. Date: Aug. 31, 2006

(54) Flashlight with magnetic switch

(75) Inventor: Rainer Opolka, Solingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: ZWEIBRUDER OPTOELECTRONICS GMBH

(21) Appl. No.: 11/362,467

(22) Filed: Feb. 24, 2006

(30) Foreign Application Priority Data
Feb. 26, 2005 (DE) 202005003128.3

(51) Int. Cl. F21L 4/04

(52) U.S. Cl. 362/205; 362/202

(57) ABSTRACT

A flashlight has a housing, a light source in the housing, a power source in the housing, and a switch having a magnetically attractable actuating element in the housing movable between an on position for connecting the power source to the light source and an off position for disconnecting the power source from the light source. A control element shiftable on the housing between a pair of end positions carries a magnet juxtaposable through the housing wall with the magnetic actuating element such that movement of the control element between its end positions shifts the actuating element between its on and off positions.

### FIELD OF THE INVENTION

The present invention relates to a flashlight.

### BACKGROUND OF THE INVENTION

A typical flashlight has a housing provided at one end with a light source and holding a battery that can be connected to and disconnected from the light source to energize or deenergize it. The switch is traditionally either provided with an external and manually operated control element that is slid, rocked, or pushed in and that is connected via some sort of linkage projecting through a hole in the housing to an internal switch mechanism. The switch mechanism can have more than two positions, to control different light sources and create different lighting effects, e.g. blinking versus steady, or to control different aspects of the light emitted, e.g. intensity or color.

No matter what the system, there is invariably a physical connection extending through an aperture in the housing wall between the external control element and the internal switch mechanism. This aperture can be a simple hole through a cylindrical housing wall, or can be formed between a pair of parts forming the housing. Either way it constitutes a path for foreign matter and liquid to find its way into the flashlight, which otherwise is relatively easy to make wholly waterproof. Furthermore the standard point of failure of such a light is at the connection between the external control element and the internal switch, for instance caused by foreign matter getting into the connection region.

### OBJECTS OF THE INVENTION

It is therefore an object of the present invention to provide an improved flashlight.

Another object is the provision of such an improved flashlight that overcomes the above-given disadvantages, in particular that can be hermetically sealed and where the connection between the external control element and the switch is particularly reliable.

### SUMMARY OF THE INVENTION

A flashlight has according to the invention a housing, a light source in the housing, a power source in the housing, and a switch having a magnetically attractable actuating element in the housing movable between an on position for connecting the power source to the light source and an off position for disconnecting the power source from the light source. A control element shiftable on the housing between a pair of end positions carries a permanent magnet juxtaposable through the housing wall with the magnetic actuating element such that movement of the control element between its end positions shifts the actuating element between its on and off positions.

According to the invention the housing is generally cylindrical and nonmagnetic. The housing also is wholly closed and hermetically contains the light source, switch, and power source. Only the control element is outside the housing and nothing projects through the housing wall between the control element and any internal elements. Thus the flashlight can be used underwater.

The control element according to the invention is a ring annularly surrounding the housing. It can have a thickened region holding the permanent magnet and forming a convenient place to grip and move the ring, either axially or angularly.

The actuating element of the switch means in accordance with the invention is also a magnet, although it is within the scope of this invention for it simply to be magnetically attractable, e.g. ferromagnetic. Either way the housing is made of a nonmagnetic material such as plastic.

The actuating element is shiftable with the control element relative to the switch which itself can be a reed switch or a dimmer. For smoothest operation this element is a ball that can roll easily inside the housing, preferably inside some sort of track or guide, for instance a guide tube inside which the ball can roll.

The light source includes at least one light-emitting diode. In addition according to the invention the light source is of variable intensity, color, or blink rate and the switch means varies the intensity, color, or blink rate of the light source.

### BRIEF DESCRIPTION OF THE DRAWING

The above and other objects, features, and advantages will become more readily apparent from the following description, reference being made to the accompanying drawing in which:

FIG. 1 is a perspective view of the flashlight according to the invention;

FIG. 2 is a side partly perspective view of the flashlight; and

FIG. 3 is an end view of the flashlight.

### SPECIFIC DESCRIPTION

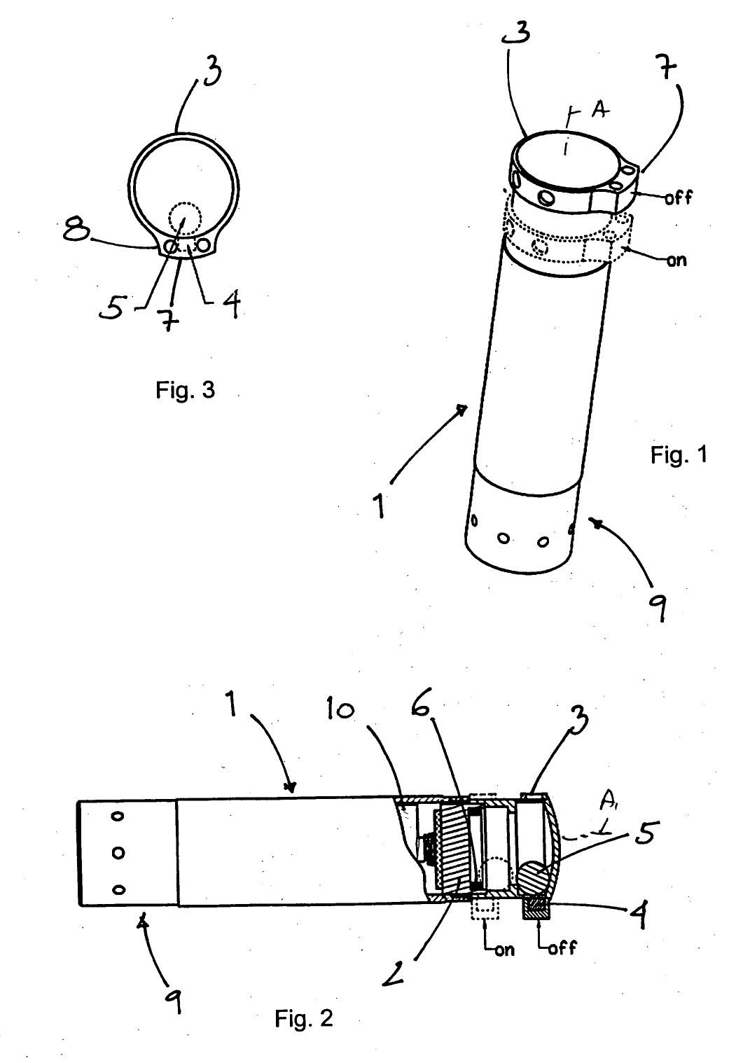

As seen in FIG. 1 a flashlight has a generally cylindrical housing 1 provided at one end with a light source 9 comprised of one or more light-emitting diodes and internally holding as shown in FIG. 2 at least one battery 10. A reed-type or dimmer switch 2 inside the housing 1 can either be of the on-off type so as to energize or deenergize the source 9 from the battery 10 or can vary the intensity, color, or frequency of the light emitted by the source 9. The switch 2 has one or more reed elements 6 for control of the source 9.

According to the invention and as also shown in FIG. 3 a control element 3 formed as a ring annularly surrounds the housing 1 and is axially shiftable thereon between on and off positions, although it could also be shiftable angularly. This ring 3 has a thickened region 7 in which is imbedded a magnet 7 that can act on an actuating element 5 that is also a spherical magnet inside the housing 1. To this end the housing 1 is of nonmagnetic material, e.g. aluminum or plastic. The thickened region 9 forms a pair of convenient recesses 8 that make it easy to grip and axially shift and/or twist the ring 3 with the fingers.

In the on position the ring 3 shifts the actuating element 5 so that it acts on the reed switch 6 and energizes the LED source 9 from the battery 10. In the off position the source 9 is deenergized.

I claim:

1. A flashlight comprising:
a housing;
a light source in the housing;
a power source in the housing;
switch means including a magnetically attractable actuating element in the housing movable between an on position for connecting the power source to the light source and an off position for disconnecting the power source from the light source;
a control element shiftable on the housing between a pair of end positions;
a permanent magnet mounted on the control element and juxtaposable with the magnetic actuating element such that movement of the control element between its end positions shifts the actuating element between its on and off positions.

2. The flashlight defined in claim 1 wherein the housing is generally cylindrical and nonmagnetic.

3. The flashlight defined in claim 2 wherein the control element is a ring annularly surrounding the housing.

4. The flashlight defined in claim 1 wherein the actuating element of the switch means is also a magnet.

5. The flashlight defined in claim 4 wherein the actuating element is shiftable with the control element relative to the switch means.

6. The flashlight defined in claim 4 wherein the switch means is a reed switch.

7. The flashlight defined in claim 1 wherein the switch means is a dimmer.

8. The flashlight defined in claim 1 wherein the light source includes at least one light-emitting diode.

9. The flashlight defined in claim 1 wherein the light source is of variable intensity and the switch means varies the intensity of the light source.
